(19) United States
(12) Patent Application Publication
(10) Pub. No.: US 2009/0275460 A1
(43) Pub. Date: Nov. 5, 2009

(54) OPTICAL GLASS

(75) Inventor: Masaaki Miyata, Kanagawa (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OHARA INC., Sagamihara-shi, Kanagawa (JP)

(21) Appl. No.: 12/094,814

(22) PCT Filed: Nov. 22, 2006
(86) PCT No.: PCT/JP2006/323880

§ 371 Date: May 23, 2008

(30) Foreign Application Priority Data
Nov. 24, 2005 (JP) 2005-338718

(51) Int. Cl. C03C 3/16; C03C 3/12; C03C 3/064; C03C 3/068; C03C 3/066; C03C 3/062

(52) U.S. Cl. 501/45; 501/41; 501/77; 501/78; 501/79; 501/73

(57) ABSTRACT

An optical glass having optical constants of a refractive index (nd) within a range from 1.50 to 1.65 and an Abbe number (ν d) within a range from 50 to 65 and a glass transition temperature (Tg) of 400° C. or below wherein the shortest wavelength (λ 80) at which transmittance is 80% is 370 nm or below.

### TECHNICAL FIELD

This invention relates to an optical glass having optical constants of a refractive index (nd) within a range from 1.50 to 1.65 and an Abbe number (ν d) within a range from 50 to 65 and also having a glass transition temperature (Tg) of 400° C. or below.

### BACKGROUND ART

In a case where a formed glass product is produced by reheat press molding, a very high temperature is required and this expedites deterioration of a heat treatment furnace and, as a result, hampers stable production. Therefore, the lower a viscous flow temperature of a glass material is, i.e., the lower a glass transition temperature (Tg) of the glass material is, the lower is the temperature at which reheat press molding can be made with resulting reduction in the load to the heat treatment furnace. The term “viscous flow temperature” herein means a temperature at which viscous flow starts and it is known in the art that it is about the same as the glass transition temperature.

In producing a formed glass product such as aspherical lenses by precision press molding, it is necessary to press and mold a heated and thereby softened lens preform under a high temperature environment for transferring a highly accurate molding surface of a mold to the lens preform and, therefore, the mold used is exposed also to a high temperature and a high pressure by the press is applied to the mold. For this reason, in heating and thereby softening the lens preform and press molding the lens preform, the molding surface of the mold tends to be oxidized and corroded with the result that a release film provided on the molding surface of the mold is damaged and thereby a highly accurate molding surface of the mold cannot be maintained and even the mold itself tends to be damaged. In that case, the mold must be replaced and therefore frequency of replacement of the mold increases and difficulty arises in realizing a large scale production. Accordingly, from the standpoint of preventing such damage and maintaining a highly accurate molding surface of the mold for a long period of time and also enabling precision press molding under a relatively low pressure by the press, it is desired that glass used for precision press molding and glass of a lens preform used for precision press molding should have as low a glass transition temperature (Tg) as possible.

As glass having a low glass transition temperature, known in the art is glass comprising PbO or TeO₂. Since, however, these components are undesirable components for protection of the environment and, moreover, tend to decrease Abbe number (ν d). As glass which has realized a low glass transition temperature without comprising PbO, there is known, for example, a P₂O₅—RO—R₂O type of glass. This type of glass, however, increases R₂O components for obtaining a low glass transition temperature and, therefore, has the disadvantage that chemical durability is not good.

For improving this point, Japanese Patent Application Laid-open Publication No. 60-171244, for example, discloses P₂O₅—B₂O₃—Al₂O₃—R₂O glass which has improved chemical durability by comprising La₂O₃. In this publication, however, limitation of numerical values is insufficient and no examples of a composition that satisfy the above described conditions are disclosed and, therefore, from the standpoint of press molding, this glass is not particularly suitable for press molding.

Japanese Patent Application Laid-open Publication No. 2004-217513 discloses a P₂O₅—R₂O (R═Li, Na, K)—ZnO—BaO optical glass. Since, however, the optical glass which is specifically disclosed in this publication contains a large amount of ZnO, it lacks in thermal stability with the result that when, for example, a preform for press molding is made from molten glass, devitrification tends to take place and therefore work efficiency is deteriorated. Moreover, the glass disclosed in this publication contains a relatively large amount of Nb₂O₅, Bi₂O₃ and WO₃ and hence it tends to be colored with the result that transmittance is deteriorated.

Japanese Patent Application Laid-open Publication No. 2004-315324 discloses a P₂O₅—R₂O (R═Li, Na, K)—BaO optical glass. Since, however, the optical glass which is specifically disclosed in this publication contains a large amount of MgO, there is a disadvantage that only an optical glass having a relatively high glass transition temperature can be obtained.

Japanese Patent Application Laid-open Publication No. 2002-211949 discloses a P₂O₅— BaO optical glass. Since, however, this optical glass contains a large amount of B₂O₃, Al₂O₃ and RO and a small amount of ZnO and R₂₀, there is a disadvantage that a softening temperature becomes high.

Japanese Patent Application Laid-open Publication No. 2004-168593 discloses a P₂O₅—ZnO—BaO optical glass. Since, however, this optical glass, however, contains a large amount of rare earth oxides, there is a disadvantage that only an optical glass having a large refractive index can be obtained.

Japanese Patent Application Laid-open Publication No. 2-124743 discloses a P₂O₅— ZnO optical glass. Since, however, this optical glass contains an excessive amount of Al₂O₃ for improving chemical durability, there is a disadvantage that only an optical glass having a high yield temperature (At) can be obtained.

### DISCLOSURE OF THE INVENTION

It is an object of the invention to provide an optical glass having a low glass transition temperature and excellent chemical durability, containing no component that is undesirable for protection of the environment, and having good adaptability for press molding.

Studies and experiments made by the inventor of the present invention for achieving the above object of the invention have resulted in the finding, which has led to the present invention, that, by adding components including P₂O₅, BaO, ZnO and alkali components at a specific ratio, a glass having optical constants of a refractive index (nd) within a range from 1.5 to 1.65 and an Abbe number (ν d) within a range from 50 to 65 and a glass transition temperature (Tg) of 400° C. or below can be made without adding a material which is undesirable for protection of the environment and the glass made in this manner has very good adaptability for precision press molding.

Further, the inventor has made it possible to adjust the above described desired optical constants by adding only small amounts of Nb₂O₅, Bi₂O₃ and WO₃ whereby good transmittance can be maintained.

In the first aspect of the invention, there is provided an optical glass having optical constants of a refractive index (nd) within a range from 1.50 to 1.65 and an Abbe number (ν d) within a range from 50 to 65 and a glass transition temperature (Tg) of 400° C. or below wherein the shortest wavelength (λ 80) at which transmittance is 80% is 370 nm or below.

According to the invention, by having a glass transition temperature of 400° C. or below, press molding at a lower temperature than in the past becomes possible and, therefore, wear of the mold due to oxidizing of the mold surface is reduced and the life of the mold thereby can be prolonged. Besides, an optical glass having this Tg can be molded by a stainless steel mold also and, as a result, the manufacturing cost of the optical glass can be significantly reduced.

In the second aspect of the invention, there is provided an optical glass of the first aspect comprising P₂O₅, ZnO, BaO and Sb₂O₃ as essential components.

In the third aspect of the invention, there is provided an optical glass of the first or second aspect comprising, in mass % on oxide basis, Nb₂O₅, WO₃ and Bi₂O₃ in a total amount of less than 3%.

In the fourth aspect of the invention, there is provided an optical glass of any of the first to third aspects comprising three kinds or more of alkali metal oxides.

In the fifth aspect of the invention, there is provided an optical glass of any of the first to fourth aspects wherein a ratio in mass % on oxide basis of an amount of ZnO to a total mount of RO components (R is one or more selected from the group consisting of Ba, Ca, Mg, Sr and Zn) is 0.2 or over.

In the sixth aspect of the invention, there is provided an optical glass of any of the first to fifth aspects comprising, in mass % on oxide basis, SiO₂, B₂O₃ and Al₂O₃ in a total amount of 1% or below.

In the seventh aspect of the invention, there is provided an optical glass of any of the first to sixth aspects comprising as essential components, in mass % on oxide basis,

| | |
|---|---|
| P₂O₅ | 40-55% |
| BaO | 20-40% |
| ZnO | 5-20% |
| Sb₂O₃ | 0.1-10%. |

In the eighth aspect of the invention, there is provided an optical glass of any of the first to seventh aspects comprising, in mass % on oxide basis, Sb₂O₃ in an amount of 1.5% or over.

In the ninth aspect of the invention, there is provided an optical glass of the seventh or eighth aspect further comprising, in mass % on oxide basis;

| Li₂O | 1-5% and/or |
|---|---|
| Na₂O | 1-10% and/or |
| K₂O | 1-10% and |
| SiO₂ | 0-2% and/or |
| B₂O₃ | 0-3% and/or |
| Al₂O₃ | 0-3% and/or |
| Y₂O₃ | 0-3% and/or |
| La₂O₃ | 0-1.5% and/or |
| Gd₂O₃ | 0-1.3% and/or |
| TiO₂ | 0-5% and/or |
| Ta₂O₅ | 0-10% and/or |
| MgO | 0-5% and/or |
| CaO | 0-5% and/or |
| SrO | 0-5% and/or |
| ZrO₂ | 0-3%. |

In the tenth aspect of the invention, there is provided an optical element made by precision press molding an optical glass of any of the first to ninth aspects.

In the eleventh aspect of the invention, there is provided a preform for precision press molding made from an optical glass of the first to ninth aspects.

In the twelfth aspect of the invention, there is provided an optical element made by precision press molding a preform of the eleventh aspect.

By adopting the above described construction, the optical glass of the invention is suitable for molding of a molten preform and has good adaptability for press molding.

By obtaining a preform by a melt dripping process and producing a lens by press molding this preform, desired optical constants, chemical durability, resistance to devitrification, adaptability for preform molding and adaptability for press molding can be achieved and molding can be made at a lower temperature than in the past and, as a result, the manufacturing cost can be significantly reduced.

### DESCRIPTION OF PREFERRED EMBODIMENTS

Desired properties of the optical glass of the present invention will now be described.

The optical glass of the invention should preferably have a refractive index (nd) within a range from 1.50 to 1.65 and an Abbe number (ν d) within a range from 50 to 65 based on requirements of optical design. In the past, glasses of various compositions have been employed for realizing these optical constants but those satisfying these optical constants mostly have a glass transition temperature (Tg) exceeding 400° C. and, as a result, in precision press molding, an inexpensive mold made of stainless steel, for example, cannot be used and the manufacturing cost tends to increase. In the optical glass of the invention, a much lower glass transition temperature than in the past is required and the glass transition temperature should preferably be 400° C. or below, more preferably be 370° C. or below, and most preferably be 350° C. or below.

Since a formed product of the optical glass of the invention must be used as an optical element, the optical glass should preferably have the highest possible transmittance. More specifically, the shortest wavelength (λ 80) at which transmittance is 80% should preferably be 370 nm or below, more preferably be 365 nm and most preferably be 360 nm.

Reason for limiting the range of composition of the respective components of the optical glass of the invention will now be described. In the present specification, unless otherwise defined, amounts of the glass composition are expressed in mass % on oxide basis.

In the present specification, the term “on oxide basis” is used to express content of each component of the optical glass and means that, assuming that oxides, nitrates etc. which are used as raw materials of the glass composition of the present invention have all been decomposed and converted to oxides during the melting process, each component of the glass comprises a particular ratio to the total mass of the converted oxides which is 100 mass %.

P₂O₅ is an essential component for forming a glass. If the amount of this component is not sufficient, resistance to devitrification is deteriorated whereas if the amount of this component is excessive, chemical durability is reduced. Therefore, the lower limit of the amount of this component should preferably be 40%, more preferably be 42% and most preferably be 44%, and the upper limit of the amount of this component should preferably be 55%, more preferably be 53% and most preferably be 51%.

BaO is an important component for adjusting optical constants. If the amount of this component is not sufficient, this effect cannot be achieved sufficiently whereas if the amount of this component is excessive, a desired glass transition temperature cannot be obtained. Therefore, the lower limit of the amount of this component should preferably be 20%, more preferably be 22% and most preferably be 24%, and the upper limit of the amount of this component should preferably be 40%, more preferably be 38% and most preferably be 36%.

ZnO is effective for lowering the glass transition temperature and adjusting optical constants. If the amount of this component is not sufficient, these effects cannot be achieved sufficiently whereas if the amount of this component is excessive, chemical durability tends to be deteriorated. Therefore, the lower limit of the amount of this component should preferably be 5%, more preferably be 7% and most preferably be 9%, and the upper limit of the amount of this component should preferably be 20%, more preferably be 17% and, particularly for maintaining chemical durability and a desired Abbe number, it should preferably be 14% or below.

Sb₂O₃ is an important component not only for defoaming but also for adjusting optical constants. If the amount of this component is not sufficient, these effects cannot be achieved sufficiently whereas if the amount of this component is excessive, a desired glass transition temperature cannot be obtained. Therefore, the lower limit of the amount of this component should preferably be 0.1%, more preferably be 1.0% and most preferably be 1.5%, and the upper limit of the amount of this component should preferably be 10%, more preferably be 7% and most preferably be 5%.

Li₂O is an essential component for lowering the glass transition temperature. If the amount of this component is not sufficient, this effect cannot be achieved sufficiently whereas if the amount of this component is excessive, resistance to devitrification is sharply deteriorated. Therefore, the lower limit of the amount of this component should preferably be 1%, more preferably be 1.3% and most preferably be 1.5%, and the upper limit of the amount of this component should preferably be 5%, more preferably be 4% and most preferably be 3%.

Na₂O is effective for lowering the glass transition temperature. If the amount of this component is not sufficient, this effect cannot be achieved sufficiently whereas if the amount of this component is excessive, resistance to devitrification is sharply deteriorated. Therefore, the lower limit of the amount of this component should preferably be 1%, more preferably be 1.5% and most preferably be 2%, and the upper limit of the amount of this component should preferably be 10%, more preferably be 8% and most preferably be 7%.

K₂O is effective for lowering the glass transition temperature. If the amount of this component is not sufficient, this effect cannot be achieved sufficiently whereas if the amount of this component is excessive, resistance to devitrification is sharply deteriorated. Therefore, the lower limit of the amount of this component should preferably be 1%, more preferably be 1.5% and most preferably be 2%, and the upper limit of the amount of this component should preferably be 10%, more preferably be 8% and most preferably be 7%.

In the present invention, it has been found that if three or more kinds of alkali metal oxides are added, stability of glass and resistance to devitrification are significantly improved compared with a case where one or two alkali metal oxides are added. Therefore, for manufacturing the glass with a high yield in the manufacturing process, it is preferable to add three or more kinds of alkali metal oxides.

B₂O₃ is a component which may be added for improving resistance to devitrification. If the amount of this component is excessive, a desired glass transition temperature cannot be obtained. Therefore, the upper limit of the amount of this component should preferably be 3%, more preferably be 2.5% and most preferably be 2%. In a case where Tg should be set at 350° C. or below, the amount of this component should preferably be 1% or below, more preferably be 0.4% or below and most preferably be 0.3% or below.

SiO₂ may be added for adjusting optical constants. If the amount of this component is excessive, a desired glass transition temperature cannot be obtained. Therefore, the upper limit of the amount of this component should preferably be 2%, more preferably be 1.5% and most preferably be 1%.

Al₂O₃ may be added for improving chemical durability. If the amount of this component is excessive, a desired glass transition temperature cannot be obtained. Therefore, the upper limit of the amount of this component should preferably be 3%, more preferably be 2.5% and most preferably be 2%.

If a total amount of B₂O₃, SiO₂ and Al₂O₃ becomes excessively large, the glass transition temperature tends to become high and a desired glass therefore cannot be obtained. Therefore, the upper limit of the total amount of these components should preferably be 1%, more preferably be 0.9% and most preferably be 0.8%.

Y₂O₃ may be added for adjusting optical constants. If the amount of this component is excessive, resistance to devitrification is deteriorated and a desired glass transition temperature cannot be obtained. Therefore, the upper limit of the amount of this component should preferably be 3%, more preferably be 2.5% and most preferably be 2%.

La₂O₃ is effective for improving chemical durability by addition of a relatively small amount and it may be also added for adjusting optical constants. This component, however, is a component which deteriorates resistance to devitrification sharply in a P₂O₃ glass. Therefore, the upper limit of the amount of this component should preferably be 1.5%, more preferably be 1.3% and most preferably be 1%.

Gd₂O₃ is effective for improving chemical durability and it may be also added for adjusting optical constants. This component, however, is a component which deteriorates resistance to devitrification sharply in a P₂O₃ glass. Therefore, the upper limit of the amount of this component should preferably be 1.3%, more preferably be 1% and most preferably be 0.8%.

TiO₂ may be added for adjusting optical constants. If the amount of this component is excessive, a desired glass transition temperature cannot be obtained. Therefore, the upper limit of the amount of this component should preferably be 5%, more preferably be 4% and most preferably be 3%.

Ta₂O₅ may be added for adjusting optical constants. If the amount of this component is excessive, a desired glass transition temperature cannot be obtained. Therefore, the upper limit of the amount of this component should preferably be 10%, more preferably be 8% and most preferably be 7%.

MgO, CaO and SrO may be added for adjusting optical constants. If the amount of these components is excessive, a desired glass transition temperature cannot be obtained. Therefore, the upper limit of the amount of each of these components should preferably be 5%, more preferably be 4.7% and most preferably be 4.5%.

In a glass containing P₂O₅, BaO and ZnO as principal components as the optical glass of the present invention, if the amount of MgO among alkaline earth metal oxides becomes large, the glass transition temperature (Tg) tends to become significantly high. Since a low Tg of 400° C. or below and more preferably 350° C. or below is required in the optical glass of the present invention, the upper limit of the amount of MgO should preferably be 1%.

For manufacturing a glass having a Tg of 350° C. or below on a stable basis, a ratio of an amount of ZnO to a total amount of RO components (R is one or more selected from the group consisting of Ba, Ca, Mg, Sr and Zn) should preferably be 0.2 or over, more preferably be 0.21 and most preferably be 0.22 or over.

ZrO₂ is effective for improving chemical durability and may be added also for adjusting optical constants. If the amount of this component is excessive, resistance to devitrification is sharply deteriorated. Therefore, the upper limit of the amount of this component should preferably be 3%, more preferably be 2% and most preferably be 1.5%.

Nb₂O₅, Bi₂O₃ and WO₃ may be added for increasing the refractive index but, on the other hand, these components cause deterioration of transmittance and particularly cause significant deterioration of transmittance on the short wavelength side. Therefore, in the optical glass of the present invention, the total amount of these components should preferably be 3% or less, more preferably be 1% or less, and most preferably, these components should not be added at all.

A Pb compound has the problems that it tends to be fused to the mold during precision press molding and that it imposes such a heavy load on protection of the environment that a step for protecting the environment must be taken not only in manufacturing of the glass but also in cold processing of the glass such as polishing and disposal of the glass. For these reasons, Pb compound should not be added to the optical glass of the present invention.

F tends to cause generation of striae in producing glass gob from molten glass and, therefore, should preferably not be added.

As₂O₃, cadmium and thorium are harmful for the environment and impose a very heavy load on protection of the environment and, therefore, should not be added to the optical glass of the present invention.

In the optical glass of the present invention, components which color the glass such as V, Cr, Mn, Fe, Co, Ni, Cu, Mo, Eu, Nd, Sm, Tb, Dy and Er should preferably not be comprised. In this case, however, the term “comprise” means that these components should not be intentionally added, and does not include a case where these components are mixed as impurities.

The glass composition of the present invention is expressed in mass % and cannot be directly expressed in mol %. Respective components of the glass composition which satisfies various properties required in the present invention are expressed in mol % as follows:

| | |
|---|---|
| P₂O₅ | 35-50% |
| BaO | 18-30% |
| ZnO | 7-30% |
| Sb₂O₃ | 0.05-5% |
| B₂O₃ | 0-5% |
| Al₂O₃ | 0-7% |
| Li₂O | 3-20% |
| SiO₂ | 0-3% |
| Y₂O₃ | 0-2% |
| La₂O₃ | 0-1% |
| Gd₂O₃ | 0-1% |
| TiO₂ | 0-7% |
| Ta₂O₅ | 0-3% |
| MgO | 0-8% |
| CaO | 0-10% |
| SrO | 0-10% |
| Na₂O | 2-15% |
| K₂O | 1-10% |
| ZrO₂ | 0-3% |

### EXAMPLES

Tables 1 to 5 show compositions of examples (No. 1 to No. 20) of the optical glass of the present invention and compositions of comparative examples (No. A to D) of the prior art optical glasses together with results of measurement of refractive index (nd), Abbe number (ν d), glass transition temperature (Tg) (° C.) and λ 80 (nm) of these glasses. The amounts of the respective components in the tables are all expressed in mass % on oxide basis.

The glasses of the examples (No. 1 to No. 20) of Tables 1 to 5 can be made easily by weighing and mixing ordinary raw materials of an optical glass such as phosphate, phosphoric acid, oxides, carbonates, nitrates and hydroxides to constitute specific composition ratio shown in Tables 1 to 4, putting the mixed batch in a crucible such as a platinum crucible, melting the raw materials at a temperature within a range from 1000° C. to 1200° C. for about three to five hours depending upon melting property of the composition, stirring and thereby homogenizing the melt and thereafter casting the melt in a mold and annealing the melt.

The refractive index (nd) and Abbe number (ν d) were measured with respect to glasses which were obtained by setting the rate of lowering of annealing temperature at −25° C./Hr.

Glass transition temperature (Tg) was measured in accordance with the Japan Optical Glass Industry Standard JOGIS08²⁰⁰³, “Measuring Method of Thermal Expansion of Optical Glass”. A specimen having length of 50 mm and diameter of 4 mm was used as a test specimen.

The shortest wavelength at which transmittance is 80% (λ 80) was measured with respect to a specimen having thickness of 10 mm on the basis of spectral transmittance curve including its reflection loss.

TABLE 1

| | Example | | | | |
|---|---|---|---|---|---|
| | No. 1 | No. 2 | No. 3 | No. 4 | No. 5 |
| P₂O₅ | 43.31 | 42.81 | 43.07 | 46.43 | 48.18 |
| B₂O₃ | 0.22 | 0.22 | | | |
| Al₂O₃ | 0.33 | 0.32 | | | |
| BaO | 24.56 | 26.70 | 27.84 | 28.52 | 28.87 |
| ZnO | 11.08 | 9.66 | 9.72 | 9.96 | 10.08 |
| Li₂O | 1.67 | 1.66 | 1.67 | 1.71 | 1.73 |
| Na₂O | 3.47 | 3.43 | 3.46 | 3.54 | 3.58 |
| K₂O | 3.55 | 3.50 | 3.53 | 3.61 | 3.66 |
| CaO | | | 1.21 | 1.24 | 1.25 |
| SrO | 2.24 | 2.21 | | | |
| Ta₂O₅ | | | | | |
| Sb₂O₃ | 9.57 | 9.46 | 9.52 | 5.00 | 2.65 |
| Other | | | | | |
| Component | | | | | |
| Total | 100.00 | 100.00 | 100.00 | 100.00 | 100.00 |
| nd | 1.6109 | 1.6121 | 1.6125 | 1.5919 | 1.5814 |
| νd | 52.9 | 52.9 | 52.4 | 57.0 | 59.9 |
| Tg | 339 | 343 | 333 | 324 | 319 |
| (° C.) | | | | | |
| λ80 | | | | | 337 |
| (nm) | | | | | |
| | Example | | | | |
| | No. 6 | No. 7 | No. 8 | No 9 | No. 10 |
| P₂O₅ | 47.24 | 46.96 | 47.45 | 47.91 | 47.95 |
| B₂O₃ | | | | | |
| Al₂O₃ | | | | | |
| BaO | 29.02 | 30.11 | 29.14 | 28.82 | 28.83 |
| ZnO | 10.81 | 10.07 | 10.18 | 10.06 | 10.07 |
| Li₂O | 1.74 | 1.73 | 1.99 | 1.72 | 1.72 |
| Na₂O | 3.60 | 3.58 | 3.62 | 3.58 | 3.58 |
| K₂O | 3.67 | 3.65 | 3.69 | 3.65 | 3.65 |
| CaO | 1.26 | 1.25 | 1.26 | 1.25 | 1.25 |
| SrO | | | | | |
| Ta₂O₅ | | | | | |
| Sb₂O₃ | 2.66 | 2.65 | 2.67 | 3.00 | 2.96 |
| Other | | | | | |
| Component | | | | | |
| Total | 100.00 | 100.00 | 100.00 | 100.00 | 100.00 |
| nd | 1.5841 | 1.5847 | 1.5833 | 1.5830 | 1.5828 |
| νd | 59.8 | 59.7 | 59.6 | 59.4 | 59.6 |
| Tg | 323 | 325 | 318 | 320 | 324 |
| (° C.) | | | | | |
| λ80 | | | | 336 | |
| (nm) | | | | | |

TABLE 2

| | Example | | | | |
|---|---|---|---|---|---|
| | No. 11 | No. 12 | No. 13 | No. 14 | No. 15 |
| P₂O₅ | 48.20 | 48.49 | 48.15 | 48.10 | 47.79 |
| B₂O₃ | | | | | |
| Al₂O₃ | | | | | |
| BaO | 27.72 | 26.61 | 28.85 | 28.82 | 28.70 |
| ZnO | 10.80 | 11.54 | 9.94 | 9.73 | 9.89 |
| Li₂O | 1.73 | 1.74 | 1.73 | 1.72 | 1.72 |
| Na₂O | 3.60 | 3.62 | 3.58 | 3.58 | 3.56 |
| K₂O | 3.67 | 3.69 | 3.65 | 3.65 | 3.63 |
| CaO | 1.26 | 1.26 | 1.25 | 1.25 | 1.24 |
| SrO | | | | | |
| Ta₂O₅ | | | | | 0.73 |
| Sb₂O₃ | 3.02 | 3.04 | 2.65 | 2.64 | 2.63 |
| Other | | | ZrO₂ | ZrO₂ | |
| Component | | | 0.20 | 0.51 | |
| Total | 100.00 | 100.00 | 100.00 | 100.00 | 100.00 |
| nd | 1.5824 | 1.5818 | 1.5819 | 1.5826 | 1.5821 |
| νd | 59.5 | 59.4 | 59.7 | 59.6 | 59.5 |
| Tg | 321 | 322 | 325 | 326 | 326 |
| (° C.) | | | | | |
| λ80 | 336 | | | | 338 |
| (nm) | | | | | |

TABLE 3

| | Example | | | | |
|---|---|---|---|---|---|
| | No. 16 | No. 17 | No. 18 | No. 19 | No. 20 |
| P₂O₅ | 47.61 | 47.97 | 47.74 | 48.06 | 48.14 |
| B₂O₃ | | | | | |
| Al₂O₃ | | | | | |
| BaO | 28.53 | 27.33 | 26.95 | 28.27 | 28.38 |
| ZnO | 9.70 | 10.75 | 10.70 | 10.43 | 10.16 |
| Li₂O | 1.71 | 1.73 | 1.72 | 1.73 | 1.73 |
| Na₂O | 3.54 | 3.58 | 3.56 | 3.59 | 3.59 |
| K₂O | 3.61 | 3.65 | 3.64 | 3.66 | 3.66 |
| CaO | 1.24 | 1.25 | 1.24 | 1.25 | 1.25 |
| SrO | | | | | |
| Ta₂O₅ | 1.44 | 0.73 | 1.45 | | |
| Sb₂O₃ | 2.62 | 3.01 | 2.99 | 3.01 | 2.80 |
| Other | | | | | ZrO₂ |
| Component | | | | | 0.31 |
| Total | 100.00 | 100.00 | 100.00 | 100.00 | 100.00 |
| nd | 1.5839 | 1.5831 | 1.5847 | 1.5816 | 1.5814 |
| νd | 58.7 | 58.8 | 58.2 | 59.7 | 59.8 |
| Tg | 321 | 318 | 324 | 322 | 322 |
| (° C.) | | | | | |
| λ80 | | | | | 336 |
| (nm) | | | | | |

TABLE 4

| | Comparative Example | | | |
|---|---|---|---|---|
| | No. A | No. B | No. C | No. D |
| P₂O₅ | 55.0 | 48.0 | 47.8 | 47.8 |
| B₂O₃ | 10.0 | | 1.0 | 1.0 |
| Al₂O₃ | 1.0 | 3.6 | 2.0 | 2.0 |
| BaO | 3.0 | | 5.0 | 5.0 |
| ZnO | | | 18.0 | 22.0 |
| Li₂O | | 2.2 | 1.8 | 1.8 |
| Na₂O | | | 4.4 | 4.4 |
| K₂O | 17.0 | 7.5 | 6.7 | 6.7 |
| La₂O₃ | 5.0 | | 0.2 | 0.2 |
| Nb₂O₅ | | | 3.0 | 3.0 |
| Bi₂O₃ | | | 5.0 | 5.0 |
| Sb₂O₃ | | | 0.1 | 0.1 |
| Other | SiO₂ 3.0 | PbO 33.2 | WO₃ 5.0 | TiO₂ 1.0 |
| Component | TiO₂ 2.0 | F 18.1 | | |
| | MgO 4.0 | | | |
| Total | 100.0 | 112.6 | 100.0 | 100.0 |
| nd | 1.53 | 1.584 | 1.586 | 1.590 |
| νd | 60.3 | — | 51.9 | 49.9 |
| Tg | 430 | 245 | 347 | 358 |
| (° C.) | | | | |
| λ80 | | | 379 | 376 |
| (nm) | | | | |

As shown in Tables 1 to 4, the glasses of the examples (No. 1 to No. 20) of the present invention all have a glass transition temperature (Tg) of 350° C. or below while they had a desired refractive index.

The glasses of the examples (No. 1 to No. 20) of the present invention all have optical constants of a refractive index (nd) within a range from 1.5 to 1.65 and an Abbe number (ν d) within a range from 50 to 65.

The glasses of these examples all had excellent melting property and chemical durability.

By obtaining a preform by the melt dripping process using the glass of the present invention and manufacturing lenses by press molding this preform, molding of the preform and lenses can be made at a lower temperature than in the past while obtaining desired optical constants, chemical durability, resistance to devitrification, adaptability for preform molding and adaptability for press molding and therefore wear of the mold surface by oxidizing is reduced and, as a result, the manufacturing cost can be significantly saved.

### INDUSTRIAL APPLICABILITY

As described in the foregoing, the optical glass of the present invention is suitable for use as an optical glass having excellent adaptability for molten preform molding and press molding and is particularly suitable for manufacturing a formed glass product such as an aspherical lens by reheat press molding.

1. An optical glass having optical constants of a refractive index (nd) within a range from 1.50 to 1.65 and an Abbe number (νd) within a range from 50 to 65 and a glass transition temperature (Tg) of 400□ or below wherein the shortest wavelength (λ80) at which transmittance is 80% is 370 nm or below.

2. An optical glass as defined in claim 1 comprising P₂O₅, ZnO, BaO and Sb₂O₃ as essential components.

3. An optical glass as defined in claim 1 comprising, in mass % on oxide basis, Nb₂O₅, WO₃ and Bi₂O₃ in a total amount of less than 3%.

4. An optical glass as defined in claim 1 comprising three kinds or more of alkali metal oxides.

5. An optical glass as defined in claim 1 wherein a ratio in mass % on oxide basis of an amount of ZnO to a total mount of RO components (R is one or more selected from the group consisting of Ba, Ca, Mg, Sr and Zn) is 0.2 or over.

6. An optical glass as defined in claim 1 comprising, in mass % on oxide basis, SiO₂, B₂O₃ and Al₂O₃ in a total amount of 1% or below.

7. An optical glass as defined in claim 1 comprising as essential components, in mass % on oxide basis,

| | |
|---|---|
| P₂O₅ | 40-55% |
| BaO | 20-40% |
| ZnO | 5-20% |
| Sb₂O₃ | 0.1-10%. |

8. An optical glass as defined in claim 7 comprising, in mass % on oxide basis, Sb₂O₃ in an amount of 1.5% or over.

9. An optical glass as defined in claim 7 further comprising, in mass % on oxide basis;

| Li₂O | 1-5% and/or |
|---|---|
| Na₂O | 1-10% and/or |
| K₂O | 1-10% and |
| SiO₂ | 0-2% and/or |
| B₂O₃ | 0-3% and/or |
| Al₂O₃ | 0-3% and/or |
| Y₂O₃ | 0-3% and/or |
| La₂O₃ | 0-1.5% and/or |
| Gd₂O₃ | 0-1.3% and/or |
| TiO₂ | 0-5% and/or |
| Ta₂O₅ | 0-10% and/or |
| MgO | 0-5% and/or |
| CaO | 0-5% and/or |
| SrO | 0-5% and/or |
| ZrO₂ | 0-3%. |

10. An optical element made by precision press molding an optical glass as defined in claim 1.

11. A preform for precision press molding made from an optical glass as defined in claim 1.

12. An optical element made by precision press molding a preform as defined in claim 11.
